(19) United States
(12) Patent Application Publication
(10) Pub. No.: US 2026/0228517 A1
(43) Pub. Date: Aug. 6, 2026

(54) HEBBIAN LEARNING-BASED PHOTONIC NEURAL NETWORK SYSTEM

(71) Applicant: University of Florida Research Foundation, Incorporated, Gainesville, FL (US)

(72) Inventors: Hao Wang, Gainesville, FL (US); Volker Sorger, Gainesville, FL (US); Andrew Qiu, Gainesville, FL (US)

(21) Appl. No.: 19/458,176

(22) Filed: Jan. 23, 2026

Related U.S. Application Data
(60) Provisional application No. 63/753,719, filed on Feb. 4, 2025.

(51) Int. Cl. G06N 3/067; G06N 3/049; G06N 3/088

(52) U.S. Cl. CPC G06N 3/0675; G06N 3/049; G06N 3/088

(57) ABSTRACT

A photonic neural network system comprising a plurality of presynaptic blocks that is configured to receive presynaptic input; an integrating photodetector that is coupled to the plurality of presynaptic blocks, wherein the integrating photodetector is configured to generate a threshold signal based an accumulated presynaptic signal comprising a pair of presynaptic spiking signals; a plurality of postsynaptic blocks, wherein a postsynaptic block of the plurality of postsynaptic blocks comprises (i) an electro-optic modulator that is configured to generate a postsynaptic output and (ii) a postsynaptic micro-ring filter that is configured to generate a feedback signal based on the postsynaptic output; a microcontroller that is configured to (i) initiate the generation of the postsynaptic output based on the threshold signal and (ii) initiate the generation of the variable synaptic weight based on the pair of presynaptic spiking signals and the feedback signal.

### CROSS REFERENCE TO RELATED APPLICATION

This application claims the priority of U.S. Provisional Application No. 63/753,719, entitled “HEBBIAN LEARNING-BASED PHOTONIC NEURAL NETWORK SYSTEM,” filed on Feb. 4, 2025, the disclosure of which is hereby incorporated by reference in its entirety.

### GOVERNMENT SUPPORT

This invention was made with government support under FA9550-22-1-0532 awarded by the US Air Force Office of Scientific Research. The government has certain rights in the invention.

### TECHNICAL FIELD

Various embodiments of the present disclosure relate to artificial neural networks, and more particularly to a photonic circuit system that simulates neuronal functions based on Hebbian learning.

### BACKGROUND

Artificial intelligence has been a cornerstone of research in the past few years, making use of neural networks (NNs). Though NNs are modeled after the brain, it is not biologically plausible, meaning that many functionalities are abstracted and not modeled accurately based on the brain.

### BRIEF SUMMARY

Various embodiments described herein relate to methods, apparatus, systems, computing devices, computing entities, and/or the like for simulating neuronal functions with photonic components.

According to some embodiments, a photonic neural network system comprises a plurality of presynaptic blocks that is configured to receive presynaptic input, wherein a presynaptic block of the plurality of presynaptic blocks comprises: (i) a pair of presynaptic micro-ring filters that are configured to generate a respectively corresponding pair of presynaptic spiking signals; (ii) a pair of presynaptic photodetectors that is (a) coupled to the pair of presynaptic micro-ring filters and (b) configured to detect the pair of presynaptic spiking signals; and (iii) a phase-change material-based micro-ring modulator that is configured to generate a variable synaptic weight; an integrating photodetector that is coupled to the plurality of presynaptic blocks, wherein the integrating photodetector is configured to generate a threshold signal based an accumulated presynaptic signal comprising the pair of presynaptic spiking signals; a plurality of postsynaptic blocks, wherein a postsynaptic block of the plurality of postsynaptic blocks comprises (i) an electro-optic modulator that is configured to generate a postsynaptic output and (ii) a postsynaptic micro-ring filter that is configured to generate a feedback signal based on the postsynaptic output; a microcontroller that is configured to (i) initiate the generation of the postsynaptic output based on the threshold signal and (ii) initiate the generation of the variable synaptic weight based on the pair of presynaptic spiking signals and the feedback signal.

In some embodiments, the pair of presynaptic micro-ring filters comprises (i) a first presynaptic micro-ring filter that corresponds to a short-term average of a presynaptic spiking rate signal, and (ii) a second presynaptic micro-ring filter that corresponds to a long-term average of the presynaptic spiking rate signal. In some embodiments, (i) the plurality of presynaptic blocks are serially connected, and (ii) the plurality of presynaptic blocks are configured in accordance with wavelength division multiplexing by operating a presynaptic block of the plurality of presynaptic blocks at a specific wavelength of a plurality of wavelengths. In some embodiments, the integrating photodetector is configured to generate a postsynaptic response in accordance with the accumulated presynaptic signal meeting or exceeding a threshold criterion. In some embodiments, the postsynaptic block further comprises a postsynaptic photodetector that is coupled to the postsynaptic micro-ring filter, wherein the postsynaptic photodetector is configured to compute a long-term average of a postsynaptic spiking rate signal. In some embodiments, the microcontroller is configured to initiate the generation of the variable synaptic weight based on a Hebbian covariance learning rule. In some embodiments, the Hebbian covariance learning rule comprises determining a weight update based on a (i) difference between a short-term average of a presynaptic spiking rate signal and a long-term average of the presynaptic spiking rate signal and (ii) a difference between a short-term average of a postsynaptic spiking rate signal and a long-term average of the postsynaptic spiking rate signal.

In some embodiments, the microcontroller is configured to initiate a long-term potentiation of the variable synaptic weight based on (i) a short-term average of a presynaptic spiking rate signal exceeding a long-term average of the presynaptic spiking rate signal, and (ii) a short-term average of a postsynaptic spiking rate signal exceeding a long-term average of the postsynaptic spiking rate signal. In some embodiments, the microcontroller is configured to initiate a long-term depression of the variable synaptic weight based on one of a presynaptic difference or a postsynaptic difference is positive and the other of the presynaptic difference or the postsynaptic difference is negative, wherein (i) the presynaptic difference comprises a difference between a short-term average of a presynaptic spiking rate signal and a long-term average of the presynaptic spiking rate signal, and (ii) the postsynaptic difference comprises a difference between a short-term average of a postsynaptic spiking rate signal and a long-term average of the postsynaptic spiking rate signal. In some embodiments, the pair of presynaptic photodetectors are coupled to drop ports of the pair of presynaptic micro-ring filters. In some embodiments, initiating the generation of the postsynaptic output comprises activating the electro-optic modulator to initiate a postsynaptic spike. In some embodiments, (i) the plurality of presynaptic blocks correspond to a plurality of input synapses, (ii) the microcontroller corresponds to a soma, and (iii) the postsynaptic block corresponds to an output synapse. In some embodiments, the presynaptic input comprises one or more spike signals that are received through a grating coupler. In some embodiments, the variable synaptic weight is normalized such that a sum of one or more synaptic weights, including the variable synaptic weight, for the microcontroller is held at a constant value.

### BRIEF DESCRIPTION OF THE DRAWINGS

Embodiments incorporating teachings of the present disclosure are shown and described with respect to the figures presented herein.

FIG. 1 depicts a diagram of an example spiking neural network (SNN).

FIG. 2 depicts a diagram of an example topology of a SNN.

FIG. 3 depicts a schematic diagram of an example photonic neural network system in accordance with some embodiments of the present disclosure.

FIG. 4 depicts a graph that summarizes when LTP and LTD occur based on the Hebbian covariance learning rule in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides a photonic neural network system that integrates photonic components to emulate complex neuronal functions. By leveraging phase-change materials (PCMs) for synaptic weighting and harnessing precise control of light through micro-ring filters and modulators, a photonic neural network system is disclosed that provides an improved paradigm for replicating synaptic plasticity and neuronal processing in the photonic domain. In this way, energy-efficient, brain-inspired neuromorphic hardware may be developed by incorporating Hebbian learning principles. The disclosed photonic neural network system may enhance cognitive AI systems with biologically-inspired learning mechanisms and enable the creation of hybrid models that combine Hebbian learning with other paradigms, such as backpropagation, to deliver more robust and versatile learning algorithms.

In some embodiments, a photonic neural network system comprises a plurality of presynaptic photonic synapse blocks (PSBs) that are representative of input synapses, a microcontroller representative of a soma, and a plurality of postsynaptic PSBs that are representative of output synapses. The photonic neural network system may provide a platform for implementing neural dynamics at speeds significantly exceeding those of biological systems. In some embodiments, phase change material is used for synaptic weighting and precise control of light through micro-ring filters. In some embodiments, modulators provide emulation of synaptic plasticity and neuronal processing in a photonic domain.

### Example System Architecture

Neuromorphic computing may provide a more biologically plausible option for providing spiking neural networks (SNNs) that mimic the way biological neurons operate. A neuron may comprise a synapse, dendrite, soma, and axon, each with its own specific functionality. A synapse may comprise a junction between two neurons, acting as a bridge to transport information. The effectiveness of signal transfer, referred to as the synaptic weight, may depend on both the number of neurotransmitters released by a presynaptic neuron and the number of receptors available at a postsynaptic neuron to convert a signal to electric current. For example, the larger the synaptic weight, the larger the current received by the postsynaptic neuron. Dendrites may act as receivers and somas may perform a leaky integration, where signals are added together but the sum decays over time. When integrated signals exceed a certain threshold, the soma may fire a spike signal output that travels down an axon. While each neuron may comprise one axon and one soma, a neuron may comprise dozens of dendrites and thousands of synapses.

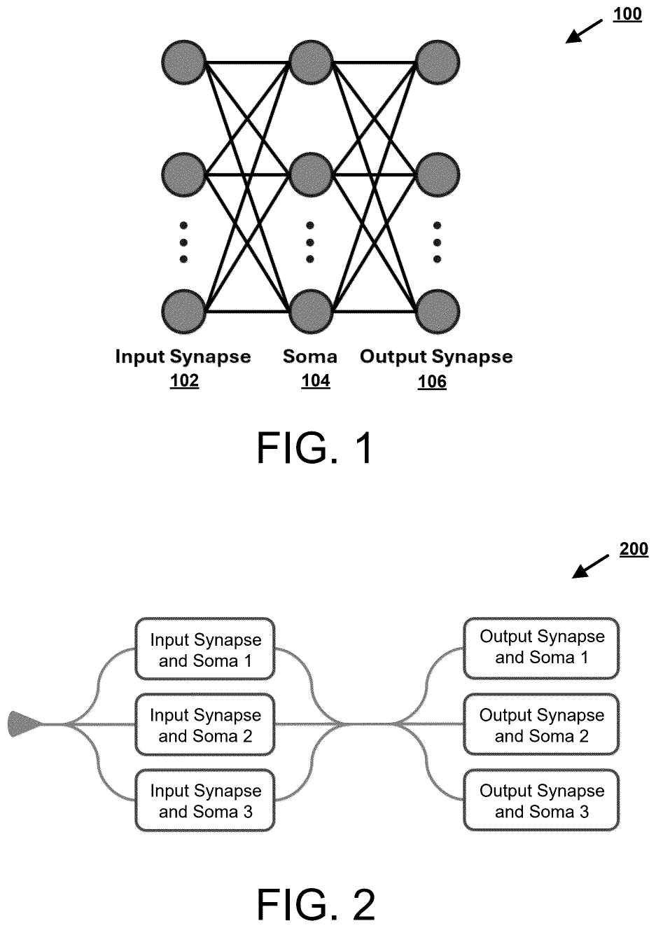

FIG. 1 depicts an example spiking neural network (SNN) 100. The SNN 100 may comprise an artificial neural network that mimics neural structures to emulate neurobiological processes. That is, in the SNN 100, input that is received at dendrites may be modeled as an input synapse 102; a soma 104 may be representative of a cell body where one or more input signals from the input synapse 102 are integrated and processed to generate an output spike; and output may be transmitted through an axon to other neurons, which may be modeled as an output synapse 106.

FIG. 2 depicts a diagram of an example topology of a SNN 200. Data signals may be received at input synapses and travel through a soma to output synapses similar to how dendrites and a cell body (soma) receive signals in a biological neuron. A soma (e.g., soma 104) may be viewed as a central processing unit of a neuron that integrates signals from input synapses (e.g., input synapse 102) before generating corresponding output spikes on the axon as output synapses (e.g., output synapse 106).

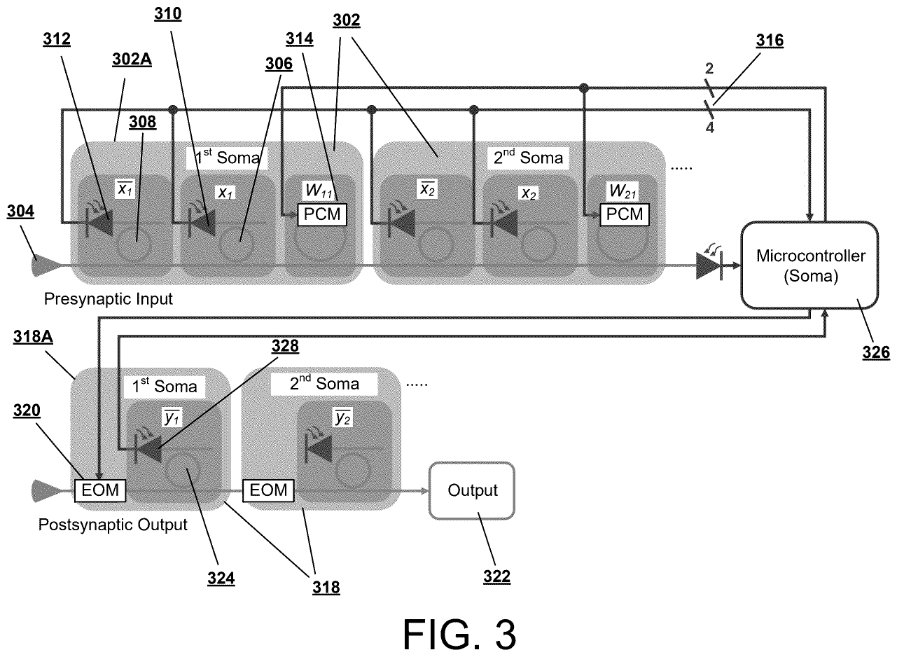

FIG. 3 depicts an example circuit diagram of a photonic neural network system 300 in accordance with some embodiments of the present disclosure. The photonic neural network system 300 comprises a photonic circuit implementation of an SNN. The photonic neural network system 300 may comprise an architecture that is based on (1) input and synaptic emulation, (2) wavelength division and integration, and (3) output and feedback loop. The architecture may comprise components, such as micro-ring filters for wavelength-specific signal processing, photodetectors for signal detection, and phase change material-based micro-ring modulators that function as adaptive memory elements. In some embodiments, the photonic neural network system 300 is configured to employ the Hebbian covariance learning rule for synaptic plasticity by adjusting synaptic weights in a SNN based on the timing of spikes from pre-synaptic neurons and/or postsynaptic neurons.

The photonic neural network system 300 comprises a plurality of presynaptic PSBs 302 that are serially-connected and configured to receive presynaptic input 304. A presynaptic PSB (e.g., 302A) of the plurality of presynaptic PSBs comprises (i) a pair of presynaptic micro-ring filters (e.g., 306 and 308) that are configured to generate a respectively corresponding pair of presynaptic spiking signals xₙ and x̅ₙ̅, (ii) a pair of presynaptic photodetectors (e.g., 310 and 312) that is (a) coupled to the pair of presynaptic micro-ring filters (e.g., 306 and 308), respectively and (b) configured to detect the pair of presynaptic spiking signals xₙ and x̅ₙ̅, and (iii) a phase-change material-based micro-ring modulator (e.g., 314) that is configured to generate a variable synaptic weight Wₙₘ. The photonic neural network system 300 comprises an integrating photodetector 316 that is coupled to the presynaptic photodetectors (e.g., 310 and 312) of the plurality of presynaptic PSBs 302, wherein the integrating photodetector 316 is configured to generate a threshold signal based an accumulated presynaptic signal comprising one or more pairs of presynaptic spiking signals (e.g., x₁ and x̅₁̅, x₂ and x̅₂̅, . . . , xₙ and x̅ₙ̅).

The photonic neural network system 300 comprises a plurality of postsynaptic PSBs 318. A postsynaptic PSB (e.g., 318A) comprises (i) an electro-optic modulator (EOM) (e.g., 320) that is configured to generate a postsynaptic output 322 and (ii) a postsynaptic micro-ring filter 324 that is configured to generate a feedback signal y̅ₘ̅ based on the postsynaptic output 322. The photonic neural network system 300 further comprises a microcontroller 326 that is configured to (i) initiate the generation of the postsynaptic output 322 (e.g., by the EOM 320) based on a threshold signal generated by the integrating photodetector 316 and (ii) initiate the generation of one or more variable synaptic weights (e.g., W₁₁, W₂₁, . . . , Wₙₘ) based on one or more pairs of presynaptic spiking signals (e.g., x₁ and x̅₁̅, x₂ and x̅₂̅, . . . , xₙ and x̅ₙ̅) and one or more feedback signals (e.g., y̅₁̅, y̅₂̅, . . . , y̅ₘ̅).

### Input and Synaptic Emulation

As disclosed herewith, the photonic neural network system 300 comprises a plurality of presynaptic PSBs 302 that is representative of input synapses, a microcontroller that is representative of a soma, and a plurality of postsynaptic PSBs 318 that is representative of output synapses. In some embodiments, a presynaptic PSB (e.g., of the plurality of presynaptic PSBs 302) is representative of a presynaptic cell or neuron. In some embodiments, a presynaptic PSB comprises two cascaded micro-ring filters, one (e.g., 306) to compute a short-term average of a presynaptic spiking rate signal xₙ and one (e.g., 308) to compute a long-term average of the presynaptic spiking rate signal x̅ₙ̅. In some embodiments, a micro-ring filter comprises a compact optical device that selectively transmits or rejects specific wavelengths of light based on resonance. Micro-ring filters may be used in integrated photonic circuits for wavelength division multiplexing (WDM), signal filtering, and/or sensing applications.

The plurality of presynaptic PSBs 302 may receive the presynaptic input 304 that comprises spike signals that enter the photonic neural network system 300 through a grating coupler at a presynaptic end, simulating a presynaptic neuron's axon terminal. In some embodiments, a grating coupler comprises a device that is used to couple light between a fiber optic cable and an integrated photonic chip. The grating coupler may comprise a periodic structure (grating) etched or patterned onto the surface of the chip, which redirects light traveling through the fiber optic cable into the chip (or vice versa) at an angle.

Two photodetectors (e.g., 310 and 312) are coupled to drop ports of presynaptic micro-ring filters (e.g., 306 and 308) to detect incoming light signals corresponding to neuronal spikes. In some embodiments, a photodetector comprises a device that converts light (e.g., photons) into electrical signals. Photodetectors may be used in optical systems to enable detection and measurement of light in various applications, such as communications, imaging, and/or sensing.

A presynaptic PSB further comprises a PCM-based micro-ring modulator (e.g., 314) that functions as a variable synaptic weight (e.g., W₁₁). In some embodiments, a micro-ring modulator comprises a compact device that modulates light by controlling its amplitude, phase, or frequency. Micro-ring modulators may be used in optical communication systems to enable data encoding onto light for high-speed transmission. In some embodiments, PCMs comprise materials that reversibly switch between different physical states, such as crystalline and amorphous, under the application of external stimuli, such as heat or electrical current. PCMs may be used to modulate light within a micro-ring modulator by leveraging their phase-dependent change in refractive index. The phase-dependent change may enable dynamic and precise control over the optical properties of a micro-ring, allowing efficient light modulation.

### Wavelength Division and Integration

Each presynaptic PSB (e.g., of the plurality of presynaptic PSBs 302) may operate at a specific wavelength, allowing the system to handle multiple input channels by serially connecting PSBs (e.g., the plurality of presynaptic PSBs 302), each tuned to different wavelengths (e.g., spectral encoding). The serial configuration mimics dendritic integration of inputs from various synaptic connections in biological neurons. At the end of a presynaptic PSB sequence (e.g., comprising the plurality of presynaptic PSBs 302), an integrating photodetector (e.g., 316) may act as an integrator and threshold unit that assesses whether an accumulation of presynaptic signals from presynaptic PSBs of the presynaptic PSB sequence meets or exceeds a threshold criterion to trigger and/or generate a postsynaptic response, analogous to an action potential generation in a neuron's axon hillock. As such, the integrating photodetector may be configured to generate a threshold signal based on the accumulated presynaptic signal.

### Output and Feedback Loop

In some embodiments, the microcontroller 326 emulates a neuron's soma. Upon accumulated presynaptic signals reaching a threshold via an integrating photodetector (e.g., 316) to trigger and/or generate a postsynaptic response, the microcontroller 326 may receive a threshold signal from the integrating photodetector and generate the postsynaptic output 322 by initiating a postsynaptic spike. Initiating the postsynaptic spike may comprise activating an EOM (e.g., 320) on a postsynaptic PSB (e.g., 318A).

In some embodiments, a postsynaptic PSB (e.g., of the plurality of postsynaptic PSBs 318) is representative of a postsynaptic cell or neuron. A postsynaptic PSB (e.g., 318A) comprises an EOM (e.g., 320), a postsynaptic micro-ring filter (e.g., 324), and a photodetector (e.g., 328) that is coupled to the micro-ring filter. The EOM may modulate the passage of specific wavelengths, simulating the firing of a postsynaptic neuron.

The microcontroller 326 may integrate incoming presynaptic and postsynaptic signals to perform computations for synaptic weight adjustments. The photodetector (e.g., 328) attached to the postsynaptic micro-ring filter (e.g., 324) on the postsynaptic PSB (e.g., 318A) may provide a feedback mechanism by computing a long-term average of a postsynaptic spiking rate signal y̅ₘ̅ and feeding the postsynaptic spiking rate signal y̅ₘ̅ back to the microcontroller 326. A short-term average of the postsynaptic spiking rate signal yₘ may be computed within the microcontroller 326 but may also be computed with another micro-ring attached to a postsynaptic waveguide coupled to the EOM (e.g., 320). Feedback generated from a postsynaptic micro-ring filter (e.g., 324) may be used to adjust PCM weights (e.g., W₁₁, W₂₁, . . . , Wₙₘ) in the presynaptic PSBs (e.g., the plurality of presynaptic PSBs 302) based on the temporal alignment of presynaptic and postsynaptic spikes, following the principles of Hebbian learning, “cells that fire together, wire together.”

According to various embodiments of the present disclosure, a photonic on-chip system is configured to provide neurobiological Hebbian learning through temporal spiking patterns, thereby offering a comprehensive simulation of neural components, including synapses, dendrites, somas, and axons. The disclosed Hebbian learning scheme may efficiently replicate an entire neural pathway, potentially operating up to 1000 times faster than its biological counterpart. The photonic neural network system 300 may be configured to monitor both presynaptic and postsynaptic spiking signals in a temporally dependent manner to determine whether to increase or decrease synaptic weights based on Hebbian learning principles. Thus, synaptic strengths may be dynamically updated in response to neuronal activity, enabling rapid and scalable learning simulations.

### Example System Operations

Various embodiments of the present disclosure describe steps, operations, processes, methods, functions, and/or the like for controlling synaptic weights using the Hebbian covariance learning rule, which comprises a modified version of the general Hebbian learning rule. The general Hebbian learning rule states that “cells that fire together, wire together.” For example, a synaptic weight may increase if the presynaptic and postsynaptic neurons fire together, and the synaptic weight may decrease if the presynaptic and postsynaptic neurons do not fire together. A weight increase may be referred to as a long-term potentiation (LTP), and a weight decrease may be referred to as a long-term depression (LTD). If a plurality of synapses is present, each output spike from a soma may cause the plurality of synapses to increase or decrease. To determine whether a synapse causes a soma to fire, a specific weight update at each synapse ΔWₙₘ may be modeled by:

$$Δ {W}_{n m} = A ( {x}_{n} - \overline{{x}_{n}} ) ( {y}_{m} - \overline{{y}_{m}} ) * f ( {W}_{n m} ) , \qquad Equation 1$$

where A may represent a constant referred to as the learning rate, xₙ may represent a short-term average (e.g., several tens of times a spike length) of a presynaptic spiking rate signal, x̅ₙ̅ may represent a long-term average (e.g., several hundreds of times a spike length) of the presynaptic spiking rate signal, yₘ and y̅ₘ̅ may represent a short-term average and a long-term average of a postsynaptic spiking rate signal, respectively, and f(Wₙₘ) may represent a function that scales the weight update based on its current weight. The n and m may refer to the nth synapse of the mth soma. For example, in FIG. 3, W₁₁ may represent a weight corresponding to a first synapse of a first soma.

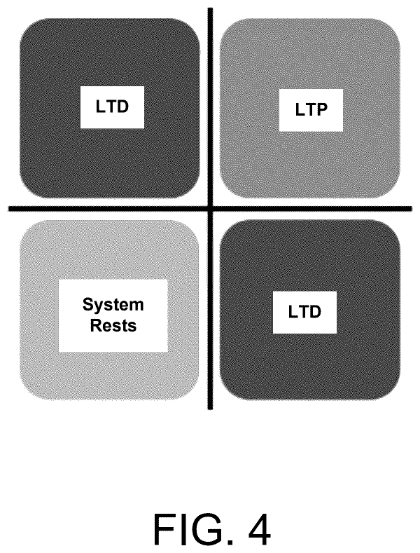

FIG. 4 depicts a graph that summarizes when LTP and LTD occur based on the Hebbian covariance learning rule in accordance with some embodiments of the present disclosure. The x-axis corresponds to xₙ−x̅ₙ̅ and the y-axis corresponds to yₘ−y̅ₘ̅. In some embodiments, a weight is updated when a soma fires an output. To achieve a positive value for ΔWₙₘ, both xₙ−x̅ₙ̅ and yₘ−yₘ may be positive given that A and f(Wₙₘ) are positive values. For example, a short-term average may be larger than a long-term average for both presynaptic and postsynaptic spikes when a soma fires. Physically, this implies that the weight between a presynaptic neuron and a postsynaptic neuron may increase if both the neurons are firing more than normal (e.g., average). If either one is firing less than normal, the weight update may be negative, and the weight may decrease. The case where both xₙ−x̅ₙ̅ and yₘ−y̅ₘ̅ are negative may be disregarded due to a resulting positive weight update being inconsistent with observations from real neurons. For example, a weight may not be updated if xₙ−x̅ₙ̅ and yₘ−y̅ₘ̅ are both negative. Another consideration regarding the synaptic weight may be that real neurons may process finite current, and as such, the weights of the synapses for a single soma may be prevented from being all large at the same time. In some embodiments, the weights may be normalized such that the sum of the synaptic weights for each soma (e.g., microcontroller 326) is held at a constant value.

Various embodiments of the present disclosure may be used or implemented in at least the following applications:
Unsupervised Learning: Hebbian learning may form the basis of many unsupervised algorithms, such as competitive learning and self-organizing maps (SOMs).
Feature Extraction: Various embodiments of the present disclosure may be used in dimensionality reduction techniques, such as principal component analysis (PCA) for extracting dominant features from datasets.
Sparse Coding: Various embodiments of the present disclosure may encourage sparsity in neural representations, improving interpretability and efficiency in models.
Memory Formation: Various embodiments of the present disclosure may model memory and associative learning mechanisms in biological brains, such as pattern recognition and recall.
Neural Plasticity: Various embodiments of the present disclosure may implement adaptive learning behaviors in neuromorphic hardware systems, enabling the neuromorphic hardware systems to self-optimize over time.
Auditory Processing: Various embodiments of the present disclosure may be used for speech segmentation and sound pattern recognition.
Synaptic Emulation: Artificial synapses may be designed to mimic Hebbian learning, enabling hardware systems to replicate brain-like learning.
Brain-Machine Interfaces (BMIs): Hebbian principles may be used to train neural interfaces to adapt to the user's brain activity, improving performance over time. Enables better understanding and decoding of brain signals for controlling external devices.
Reinforcement Learning: Various embodiments of the present disclosure may enhance the efficiency of reinforcement learning algorithms by reinforcing the connections between actions and rewards, particularly in systems where state-action mappings may require refinement.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A photonic neural network system comprising:
a plurality of presynaptic blocks that is configured to receive presynaptic input, wherein a presynaptic block of the plurality of presynaptic blocks comprises:
(i) a pair of presynaptic micro-ring filters that are configured to generate a respectively corresponding pair of presynaptic spiking signals;
(ii) a pair of presynaptic photodetectors that are (a) coupled to the pair of presynaptic micro-ring filters and (b) configured to detect the pair of presynaptic spiking signals; and
(iii) a phase-change material-based micro-ring modulator that is configured to generate a variable synaptic weight;
an integrating photodetector that is coupled to the plurality of presynaptic blocks, wherein the integrating photodetector is configured to generate a threshold signal based an accumulated presynaptic signal comprising the pair of presynaptic spiking signals;
a plurality of postsynaptic blocks, wherein a postsynaptic block of the plurality of postsynaptic blocks comprises (i) an electro-optic modulator that is configured to generate a postsynaptic output and (ii) a postsynaptic micro-ring filter that is configured to generate a feedback signal based on the postsynaptic output;
a microcontroller that is configured to (i) initiate the generation of the postsynaptic output based on the threshold signal and (ii) initiate the generation of the variable synaptic weight based on the pair of presynaptic spiking signals and the feedback signal.

2. The photonic neural network system of claim 1, wherein the pair of presynaptic micro-ring filters comprises:
(i) a first presynaptic micro-ring filter that corresponds to a short-term average of a presynaptic spiking rate signal, and
(ii) a second presynaptic micro-ring filter that corresponds to a long-term average of the presynaptic spiking rate signal.

3. The photonic neural network system of claim 1, wherein:
(i) the plurality of presynaptic blocks are serially connected, and
(ii) the plurality of presynaptic blocks are configured in accordance with wavelength division multiplexing by operating a presynaptic block of the plurality of presynaptic blocks at a specific wavelength of a plurality of wavelengths.

4. The photonic neural network system of claim 1, wherein the integrating photodetector is configured to generate a postsynaptic response in accordance with the accumulated presynaptic signal meeting or exceeding a threshold criterion.

5. The photonic neural network system of claim 1, wherein the postsynaptic block further comprises a postsynaptic photodetector that is coupled to the postsynaptic micro-ring filter, wherein the postsynaptic photodetector is configured to compute a long-term average of a postsynaptic spiking rate signal.

6. The photonic neural network system of claim 1, wherein the microcontroller is configured to initiate the generation of the variable synaptic weight based on a Hebbian covariance learning rule.

7. The photonic neural network system of claim 6, wherein the Hebbian covariance learning rule comprises determining a weight update based on a (i) difference between a short-term average of a presynaptic spiking rate signal and a long-term average of the presynaptic spiking rate signal and (ii) a difference between a short-term average of a postsynaptic spiking rate signal and a long-term average of the postsynaptic spiking rate signal.

8. The photonic neural network system of claim 1, wherein the microcontroller is configured to initiate a long-term potentiation of the variable synaptic weight based on:
(i) a short-term average of a presynaptic spiking rate signal exceeding a long-term average of the presynaptic spiking rate signal, and
(ii) a short-term average of a postsynaptic spiking rate signal exceeding a long-term average of the postsynaptic spiking rate signal.

9. The photonic neural network system of claim 1, wherein the microcontroller is configured to initiate a long-term depression of the variable synaptic weight based on one of a presynaptic difference or a postsynaptic difference is positive and the other of the presynaptic difference or the postsynaptic difference is negative, wherein (i) the presynaptic difference comprises a difference between a short-term average of a presynaptic spiking rate signal and a long-term average of the presynaptic spiking rate signal, and (ii) the postsynaptic difference comprises a difference between a short-term average of a postsynaptic spiking rate signal and a long-term average of the postsynaptic spiking rate signal.

10. The photonic neural network system of claim 1, wherein the pair of presynaptic photodetectors are coupled to drop ports of the pair of presynaptic micro-ring filters.

11. The photonic neural network system of claim 1, wherein initiating the generation of the postsynaptic output comprises activating the electro-optic modulator to initiate a postsynaptic spike.

12. The photonic neural network system of claim 1, wherein:
(i) the plurality of presynaptic blocks correspond to a plurality of input synapses,
(ii) the microcontroller corresponds to a soma, and
(iii) the postsynaptic block corresponds to an output synapse.

13. The photonic neural network system of claim 1, wherein the presynaptic input comprises one or more spike signals that are received through a grating coupler.

14. The photonic neural network system of claim 1, wherein the variable synaptic weight is normalized such that a sum of one or more synaptic weights, including the variable synaptic weight, for the microcontroller is held at a constant value.
